(19) United States
(12) Patent Application Publication
(10) Pub. No.: US 2015/0029307 A1
(43) Pub. Date: Jan. 29, 2015

(54) METHOD AND DEVICE FOR IMPROVED ULCER TREATMENT

(71) Applicants: Elias Haralabos, Athens (GR); Wolfgang Neuberger, Dubai (AE)

(72) Inventors: Elias Haralabos, Athens (GR); Wolfgang Neuberger, Dubai (AE)

(21) Appl. No.: 13/641,554

(22) PCT Filed: May 24, 2011
(86) PCT No.: PCT/US11/37673

§ 371 Date: Sep. 10, 2014

Related U.S. Application Data
(63) Continuation-in-part of application No. 12/796,863, filed on Jun. 9, 2010, now abandoned.

(51) Int. Cl. H04N 13/00; G06T 7/20

(52) U.S. Cl. CPC H04N 13/004; H04N 13/0022; G06T 7/2086; G06T 2207/10021; G06T 2207/20212; H04N 2013/0085; H04N 2013/0081
USPC 348/43

(57) ABSTRACT

A method and device are disclosed for treating ulcers based on the photobiostimulation effect to reduce inflammation and enhance microvascular activity accelerating the wound healing process. In a preferred embodiment, a diode laser source emits 1470±60 nm laser energy at about 15 Watts, which is conveyed through an optical fiber and applied onto wound with about a 7 mm spot with a laser pulse preferably set to about 60 msec. An enclosure cap at emission tip confining irradiated area results in enhanced personnel safety. A standalone handheld laser can be used without need of a fiber/handpiece. Additionally a timer or sensing system determines end of radiation treatment. An efficient, rapid, easy and safe treatment of venous, arterial and neurotrophic ulcers, chronic and acute, results. In another embodiment, a special technique is used with a point to point laser appliance, irradiating an area of about 1-2 cm out beyond the edges of the ulcers. After each treatment, a hyaluronic acid gel is generally applied. Optimum treatment can involve multiple irradiations spaced over days/weeks.

### RELATED CASE INFORMATION

This application claims the benefit and priority of U.S. Provisional Application Ser. No. 61/324,816 filed Apr. 16, 2010, entitled “Method and Device for Improved Ulcer Treatment” by Haralabos Elias, which is incorporated by reference herein.

### BACKGROUND OF THE INVENTION

1. Field of the Invention

The present invention relates to wound healing treatments, and in particular, to the treatment of ulcers by using local energy-emitting devices and conveying means.

2. Invention Disclosure Statement

The word “Ulcer” means a break in the layer of cells forming a surface. They can occur in many different areas of the body. In each different area, there are different factors that cause ulcers to form. A leg ulcer, for example is an area of damaged skin below the knee on the leg or foot that takes longer than six weeks to heal. The skin breaks down allowing air and bacteria to get into the underlying tissue. Leg ulcers appear as shallow holes or craters in which the tissue underneath is exposed. They can vary in size, color and depth. Leg ulcers can often be a long-term and recurring condition. Around 80-85% of all leg ulcers are venous leg ulcers, which develop due to poor blood circulation in leg veins. Other types of leg ulcers can include arterial leg ulcers, which result from poor circulation in the arteries, and diabetic leg ulcers, which can occur because of diabetes. Venous leg ulcers can be painful and can cause aching, itching and swelling in the affected leg. They become more common with age. It is estimated that one in every 50 people over the age of 80 is affected by venous leg ulcers. They are also more common in those who are obese or immobile. Other ulcers may be associated with metabolic disorders such as diabetes, radiation or chemically treated cancer patients, or burn victims. For example, it has been shown that a lack of insulin inhibits the healing process in diabetics by decreasing wound capillaries, fibroblasts, polymorphonuclear leukocytes, and collagen at the wound site. Additionally, platelets demonstrate an increase in aggregation, which inhibits their action. Platelets are a source of platelet-derived growth factors (PDGF) which enhance healing; therefore any lack or malfunction of the platelets and subsequently of PDGF would have an adverse effect on healing.

Wounds can become a major complication in cancer patients if microbes invade the wound site because chemotherapy suppresses the immune system. Almost all chemotherapy agents currently available kill cancer cells by affecting DNA in synthesis. For example, cyclophosphamide is an alkylating agent that is used in the treatment of chronic leukemia. Alkylating agents kill cancer cells by directly attacking DNA. However, in the process of attacking cancer cells, the alkylating agents also affect healthy cells and organs, including white blood cells and platelets thereby suppressing the patient's immune system.

Additionally, diabetics and patients with other metabolic disorders have an increased susceptibility to infection due to immune system abnormalities. Specifically, diabetics have deficiencies in white cell diapedesis, adherence, and chemotaxis. Hyperglycemia causes defective white cell phagocytosis and promotes growth of bacteria. Angiopathy, which leads to hypoxia, inhibits white blood cell (WBC) killing of bacteria by reducing the formation of superoxide radicals and impairs the delivery of antibiotics, antibodies, and granulocytes to the affected site.

Research has shown that the usual cause of ulcers is not the skin itself, but the underlying blood supply to the skin. Successful treatment of ulcers and successful prevention of ulcers must be directed at correcting the underlying cause, not the ulcer itself. Therefore treatments consisting of putting dressings and creams straight on to it, hoping the skin will grow back are not effective.

Generally, bandages, topical antibiotics, and mechanical scraping have been used as a first line of defense to treat chronic wounds. For example, a conventional treatment for venous leg ulcers involves cleaning and dressing the wound and applying pressure through compression bandages. The surface of the wound is typically cleansed and/or sterilized to enhance the body's natural healing processes. However, they can take a long time to heal and can recur even after they've fully healed. They can also become infected or develop complications. Additionally, these methods may be inadequate when natural healing mechanisms are affected by complicating factors such as chemotherapy which suppresses the immune system or diabetes which inhibits the production of collagen and/or fibroblasts at the wound site. Ablative laser skin resurfacing (LSR) has been used to induce dermal collagen shrinkage to treat facial rhytides, acne scarring, and other blemishes by ablating or vaporizing skin in very thin layers, with a high level of control and without affecting the deep layers of the dermis. However, this method would not be advantageous for wound healing because ablative methods, as is well known by those skilled in the art, are often accompanied by complications such as persistent erythema, hyperpigmentation, hypopigmentation, scarring and infection.

Non-ablative laser skin resurfacing methods eliminate the complications commonly associated with ablative laser skin resurfacing by inciting a healing response in the dermis without damaging the epidermal barrier. The risk of infection and scarring is typically eliminated and erythema is greatly reduced when treating facial rhytides because the epidermal barrier remains intact. However in wound treatment, the epidermis may be damaged prior to laser therapy, therefore, the current non-ablative skin resurfacing methods do not provide a method to prevent infection in wound therapy which is essential in cases where complicating factors are present. Additionally, non-ablative skin resurfacing methods have found a need and benefit from employing a cooling mechanism to protect the epidermis. Excess cooling can lead to fiber damage and a high radiant exposure is required for effective treatment.

Research has shown that between 40% and 60% of leg ulcers could be cured by appropriate surgery. For example, eighty percent of leg ulcers are caused by vein insufficiency. Therefore, vein ablation methods such as endovenous laser vein ablation are often used. (See for example Dermatol Surg 2007; 33:1149-1157 “Review of intravascular approaches to the treatment of varicose veins.” by Nootheti et al.) Methods may ultimately eliminate underlying cause of ulcer. Even so, wound may take a long time to cure. Furthermore, many ulcers have more than one cause, especially in elderly people.

Laser energy is reported to have beneficial effects on wound healing (see for example Nemeth A. J. (1993). “Lasers and wound healing”, Dermatology clinics 11(4):783-) by stimulating the immune system, increasing various cytokines and leukocyte population, arresting bacterial growth, increasing the amount of total collagen and skin circulation and by accelerating the regeneration processes.

Different wavelengths have been tried for treatment of ulcer wounds, for instance 810 nm wavelength. However, studies have shown that patients undergoing laser treatment of ulcers with 810 nm wavelength did not show statistically significant improvements over controlled group patients.

The absorption spectra of water illustrates a peak in the vicinity of 980 nm indicating that 980 nm light is well absorbed by water. The absorption spectra exhibits a valley in the 1064 nm range indicating that only moderate absorption can be achieved by lasers employing 1064 nm light. Thus, 980 nm radiation is preferred over 1064 nm for medical procedures involving soft tissue because greater absorption leads to higher precision, lower penetration results which is especially advantageous in the treatment of chronic wounds. Whereas, poorly absorbed wavelengths such as 1064 nm are transmitted through the tissue and penetrate deep into the dermis producing unwanted results for treating chronic wounds. Additionally, wavelengths such as 10 μm (CO₂), 3 μm (Erbium YAG) or 2 μm (Ho-Yag), which have even higher absorption coefficients than 980 nm, are counterproductive for wound treatment. The upper layer can very easily vaporize or burn before the deeper layers is sufficiently heated because the laser radiation does not penetrate to the deeper layers. Thus, the 980 nm laser is preferred to selectively injure the lower papillary/upper reticular dermis to activate the synthesis of collagen and to eradicate bacteria within the dermis to accelerate and enhance the healing process.

U.S. Pat. No. 7,177,695 by Moran proposes 980 nm electromagnetic radiation for wound healing at 5-10 Watts. This patent deals, however, with early stage wounds generally before skin is broken. Little instruction is given as to how its approach would fare with difficult open ulcers, or advanced chronic wounds.

In U.S. Pat. No. 6,165,205 Neuberger presents a method for wound healing based on applying 980 nm laser energy to wounds at a power of about 5 Watts during in continuous radiation for a time period of 10 seconds to 20 minutes. Continuous 980 nm radiation is employed; a wavelength with considerable absorption by hemoglobin. Continuous 980 nm radiation applied directly on skin for several minutes may, therefore, cause pain and discomfort to the patient, or cause damage in deeper layers.

Furthermore, although methods proposed for wound healing using 980 nm render positive results and healing time is reduced, chronic wounds still take an average of up to nine weeks to heal (see The Foot 14 (2004) 68-71, “A review of lasers in healing diabetic ulcers” by J. S. Kawalec et. al). Shorter healing times are needed not only to directly benefit patient satisfaction but also to decrease probability of infection and other complications.

Visible light has been used to irradiate wound surfaces because it has been to suggested that it stimulates and corrects other metabolic processes on the cellular level. Wavelengths used in prior art include 578 nm, 632 nm, 660 nm, 685. However published investigations comparing therapy with placebo laser treatment indicate that these wavelengths are ineffective. Examples of these conclusions can be found in the following scientific articles: I) Photodermatol. 1984 October; 1(5):245-9. “Inadequate effect of helium-neon laser on venous leg ulcers” by Santoianni et. al. and 2) J Wound Care. 2005 September; 14(8):391-4. “Does the use of low-level laser influence wound healing in chronic venous leg ulcers?” by Kopera et al.

Another type of treatment for ulcer wounds has been using Ultraviolet radiation. For example, U.S. Pat. Nos. 4,686,986 by Fenyo et. al, U.S. Pat. No. 7,409,954 by Dobkine et. al and U.S. Pat. No. 6,283,986 by Johnson teach different methods that apply light therapies in the Ultraviolet range for treating wounds and infections. Ultraviolet radiation is well known for its bactericidal effect and is therefore good for preventing infections. It is not however as effective for stimulation of biological processes for promoting the healing of lesions as other wavelengths in the near infrared portion of the light spectrum. Furthermore, ultraviolet radiation presents several risks. It is known to be carcinogenic and can cause damage to the skin, particularly sunburn and blistering.

Combination treatments have also been used on infections, trophic ulcers and non-healing wounds, to try to reduce inflammatory processes and activate the regenerative processes. For example, a combined treatment has been published in Lasers Surg Med. 2009 August; 41(6):433-41 by Minatel et. al. Authors apply combined 660 and 890 nm LED phototherapy to promote healing of diabetic ulcers that failed to respond to other forms of treatment. In another example, Neuberger et. al present in U.S. Pat. No. 6,527,764, a system for laser treatment that couples surgical or activating laser power with a biomodulating power to enhance proper tissue healing and regeneration after treatment. This treatment is achieved using an optical fiber system delivering laser power from two separate laser sources. One source provides laser energy at a power level and density suitable for the surgical or activation action desired. The second source produces laser power at a wavelength suitable for producing biomodulating effects in the treated tissue. Combined treatments are complex and require physician to be highly trained and familiar with different types of energy emitting technologies and their effect on biological tissue. Moreover it is costly, as it requires equipment able to emit and convey different types of radiation energies.

Further in U.S. Pat. No. 6,379,376 Lubart describes a method and device for inducing or promoting growth and proliferation of skin cells or tissue or for controlling bacterial skin infection. The skin cells are irradiated with a low-intensity broad spectrum light at a wavelength of between about 340 to 3,000 nm. Applying such a large a range of wavelengths simultaneously is not beneficial. The spectrum proposed in this patent, for example, includes wavelengths mentioned earlier to be ineffective or harmful.

Thus a device and method is needed to accelerate wound healing that improves on the state of the art by effectively increasing wound capillaries, fibroblasts, and collagen in the wound site, while simultaneously reducing procedure time and eliminating the risk of infection and other collateral effects. The present invention addresses these needs.

### OBJECTIVES AND BRIEF SUMMARY OF THE INVENTION

It is an objective of the present invention to provide a device and method for improved treatment of skin wounds, such as ulcers, which is safer for personnel/patients.

It is also an objective of the present invention to provide a device and method of wound healing by reducing inflammation, improving vascular activity and accelerating tissue growth and repair.

It is another objective of the present invention to safely treat ulcers effectively by using a localized, directed energy source and conveying means.

It is yet another objective of the present invention to facilitate a medical procedure for reducing size of ulcers that is effective, non-invasive, simple, painless and pain-relieving and with minimum side effects.

Briefly stated, a method and device are disclosed for treating ulcer based on the photobiostimulation effect to reduce inflammation and enhance microvascular activity accelerating the wound healing process. In a preferred embodiment, a diode laser source emits 1470±60 nm laser energy at about 15 Watts, which is conveyed through an optical fiber and applied onto wound with about a 7 mm spot with a laser pulse preferably set to about 60 msec. An enclosure cap at emission tip confining irradiated area results in enhanced personnel safety. A standalone handheld laser can be used without the need of a fiber/handpiece. Additionally a timer or sensing system determines end of radiation. An efficient, rapid, easy and safe treatment of venous, arterial and neurotrophic ulcers, chronic and acute, results. In another embodiment for treatment, a special technique is used with a point to point laser appliance, irradiating an area of about 1-2 cm out beyond the edges of the ulcers. After treatment, a hyaluronic acid gel is generally applied. Optimum treatment can involve multiple irradiations spaced over days/weeks.

The above and other objects, features and advantages of the present invention will become apparent from the following description read in conjunction with the accompanying drawings (in which like reference numbers in different drawings designate the same elements).

### BRIEF DESCRIPTION OF FIGURES

FIG. 1 depicts a preferred embodiment of present invention describing treatment device's main components.

FIG. 2 shows absorption properties of the 1470 nm wavelength in water and in blood.

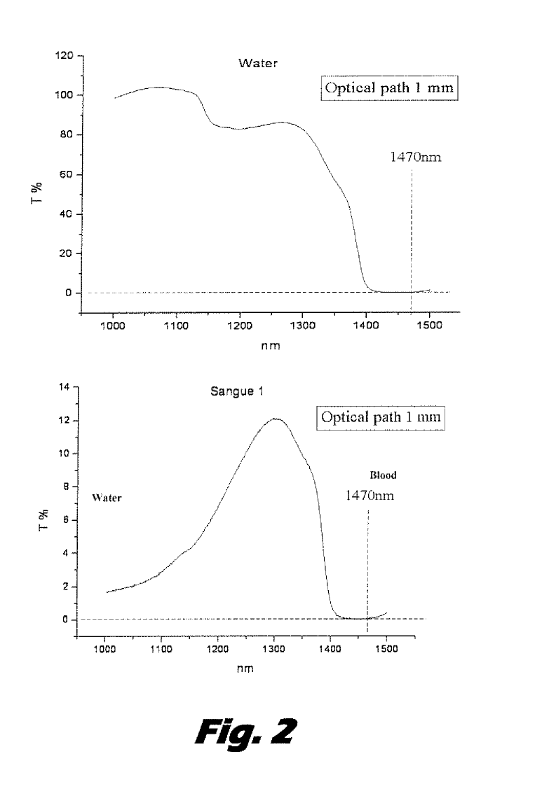

### DETAILED DESCRIPTION OF PREFERRED EMBODIMENTS

As previously mentioned, skin wounds such as ulcers present numerous and potentially dangerous complications for patients who suffer them and treatments described in prior art have not been successful in a large percentage of cases. In general terms, the present invention discloses a device and method which treats ulcerous wounds such as foot and leg ulcers by periodically applying laser energy of a specific wavelength on affected areas and at determined parameters according to characteristics of treated ulcer.

Laser is known to have beneficial effects on wound healing by stimulating the immune system, increasing various cytokines and leukocyte population, arresting bacterial growth, increasing the amount of total collagen and skin circulation and by accelerating the regeneration processes. Present invention provides optical medical treatment devices for irradiating and healing ulcer wounds. In a preferred embodiment, optical medical treatment device comprises at least one radiation source; at least one optical waveguide; and a handpiece coupled to said waveguide. Said optical waveguide has a proximal end and a distal end; and it is optically coupled to said radiation source at its proximal end and transmits radiation to a wound site at its distal end. Said radiation source is capable of producing radiation energy at a preselected wavelength preferably between about 1470±60 nm; at a preselected power level preferably in the range of about 10-20 Watts and a preselected power density. Said handpiece is capable of focusing laser energy to said wound site with a spot size within a range of about 1 to 20 mm in diameter.

Other embodiments further comprise an enclosure cap for confining irradiated area. To facilitate reproducible and precise effects, in many embodiments time of exposure is determined using added features, a timer system to signal end of treatment and/or a sensing system to signal end of treatment according to changes in target tissue properties in area of said ulcer wounds.

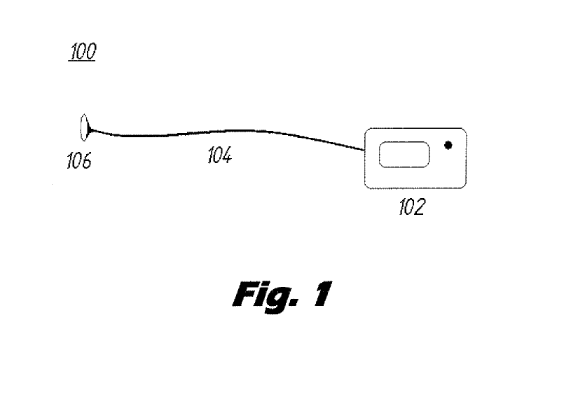

In a preferred embodiment of present invention, depicted in FIG. 1, laser device 100 comprises diode laser source 102, such as a gallium arsenide semiconductor capable of emitting up to 15 Watts, fiber optic 104 as conveying means, and application handpiece 106 with diameter chosen according to size of ulcer. In a preferred embodiment, handpiece 106 comprises an opaque closure cap to seal around the wound borders. This achieves enclosure of emitted radiation within wound area. Thus, healthy skin is protected from radiation. Additionally, patients and medical staff are safe from stray radiation reaching their eyes. Device irradiates enclosed area until treatment is finished. In a preferred embodiment, a preset timer system activates an alarm to indicate end of treatment. In another preferred embodiment a sensing system adequately placed on wound area determines end of treatment. Sensing system is based on parameters that indicate a change in tissue properties such as water content, or light absorption/reflection values.

In another preferred embodiment of present invention, a portable integrated handheld laser system directly irradiates the wound without the need of a fiber or handpiece. Such handheld laser contains a LED source or an OLED source capable of emitting a predetermined wavelength and power to achieve a desired power density. Power density is set by physician according to spot size and/or wound characteristics.

Preferred wavelength is 1470±60 nm. FIG. 1 shows absorption properties of this wavelength in water and blood. 1470 nm has an absorption coefficient in water of over 20 times greater than 980nm, so electromagnetic energy is highly absorbed in blood, due to the high content of water in blood. Thus, the 1470 nm laser is preferred to selectively injure the lower papillary/upper reticular dermis to activate the synthesis of collagen and to eradicate bacteria within the dermis to accelerate and enhance the healing process.

In a preferred embodiment, radiation energy is applied into the ulcer wound starting at the outermost edge; and then travelling inwards in circular or spiral like motions. In another embodiment, radiation energy is applied to the ulcer wound in a point-to-point style; applying about 1-2 cm outside the edges of said ulcer wound. In yet another embodiment, radiation energy is applied until a termination point based on a preset timer or sensing system endpoint.

Present laser device is capable of eradicating bacteria within the dermis to significantly reduce the risk of infection. Eradication of bacteria in the dermis is especially advantageous for treating wounds particularly in situations where the immune system is suppressed.

Present invention further provides methods of treating ulcer wounds in which said ulcer wounds are photobiostimulated to accelerate healing by applying a local energy source to said wounds. Preferably, said local energy source employs laser energy at a preselected wavelength in the range of about 1470±60 nm onto the wounds.

In a preferred embodiment, a method of treating ulcer wounds comprises the steps of preparing said ulcer wound for treatment; selecting a wavelength, a power level and a power density; transmitting pulsed radiation energy through a waveguide and/or handpiece onto said wound in a non-contact mode; applying a hyaluronic acid jell to said ulcer wound, either before during or after radiation; and repeating the prior steps periodically until size of ulcer wound shrinks or disappears.

The following example describes a preferred method applied on different patients with ulcers and clinical results obtained:

In an eight month period, 20 patients were enrolled, 10 males and 10 females, 38-87 years old, with one to up to five ulcers per case, counting a total number of 36 ulcers. All forms of ulcers were included, venous, arterial-diabetic, neurotrophic and meta-traumatic and even patients with very deep ulcers, with tendon and small bones of the toes exposed. Additionally, two patients had undergone plastic surgical operations and unsuccessful graft covering of the ulcer. The size of ulcers varied from 1 cm² up to 132 cm². From the total number of ulcers included (36), 9 were venous (superficial incompetence and metathrombotic syndrome), 8 were arterial (5 diabetic), 16 were neurotrophic and 3 traumatic. Additionally, 23 ulcers were categorized as chronic (>6 weeks) and 13 as acute (<6 weeks).

Laser treatments took place once every 7-10 days. Before the laser session, all the ulcers were cleaned with normal saline or sterile water for injection and debrided from any necrotic tissues (especially at the first session). For the niche treatment of the entire ulcerous area, a “tailor's” technique was used with point-to-point laser appliance, irradiating also an area of 1-2cm outside of the edges of the ulcers. After treatment, a hyaluronic acid jell (Jalplast) was applied. The ulcer area was measured before the start of every therapeutic session and images were taken before the start of every laser session. Laser parameters were set to 60 msec pulse duration applied through a 7 mm spot, for an average fluency (energy) of 50-70 J/cm² on the wounds.

The laser treatment was well tolerated by patients. Results evaluation was based on the progress and the level of the ulcer healing (closure), the time/sessions required for the healing, and existence of side effects.

Results showed that, 77.7% of the venous ulcers, 62.5% of the neurotrophic ulcers, 87.5% of the arterial and 100% of the traumatic were completely closed. The average healing period healing was 5.02 weeks (3-32 weeks). In detail, a healing period of 3.7 weeks for venous ulcers, 4.6 weeks for neurotrophic ulcers, 7.7 weeks for arterial ulcers, and 3.3 weeks for traumatic ulcers. 65.2% of the chronic ulcers and 100% of the acute ulcers were completely healed. The 9 ulcers that were not completely healed by the end of the study were significantly reduced in size.

Table 1 and Table 2 summarize these results.

TABLE 1
Results analysis for ulcers healing

| | | Ulcers | Average | Non |
|---|---|---|---|---|
| | Number of | completely | Heal Period | Healed |
| Form of Ulcers | Ulcers | healed | (Weeks) | Ulcers |
| VENOUS | 9 | 7 (77.7%) | 3.7 (3-20) | 2 (22.3%) |
| NEUROTROPHIC | 16 | 10 (62.5%) | 4.6 (3-8) | 6 (37.5%) |
| ARTERIAL | 8 | 7 (87.5%) | 7.7 (3-32) | 1 (12.5%) |
| TRAUMATIC | 3 | 3 (100%) | 3.3 (3-4) | − (−%) |
| TOTAL | 36 | 27 (75%) | 5.02 | 9 (25%) |

TABLE 2
Summary analysis and healing progress of the 9 non-healed ulcers

| Duration of | Type of | Size of | Treatment time (weeks) |
|---|---|---|---|
| ulcer | ulcer | Ulcer (cm²) | progress of healing |
| 10 years | venous | 132 cm² | 33 weeks/91% smaller |
| 3 years | arterial | 5.3 cm² | 13 weeks/59% smaller |
| 4 months | neurotrophic | 23.4 cm² | 3 weeks/32% smaller |
| 4 months | neurotrophic | 4.4 cm² | 3 weeks/45% smaller |
| 4 months | neurotrophic | 25.5 cm² | 3 weeks/30% smaller |
| 3.5 months | neurotrophic | 13.6 cm² | 2 weeks/24% smaller |
| 2 years | venous | 78.12 cm² | 3 weeks/76.5% smaller |
| 8 months | neurotrophic | 16.1 cm² | 3 weeks/31.8% smaller |
| 8 months | neurotrophic | 5.76 cm² | 3 weeks/29.7% smaller |

In conclusion, 75% of all the ulcers included in the example completely healed, with an especially high closure rate for acute ulcers. Additionally, laser fluency at 50-70 Joules/cm² was well tolerated by the patients. The laser wavelength 1470 nm as a source of photobiostimulation with a fluency of 50-70 J/cm² showed beneficial effects on wound healing by reducing inflammation, improving vascular activity and accelerating tissue growth and repair. It has proved to be an effective, non invasive, simple, painless and pain-relieving treatment with no reported side effects for ulcer wound healing.

In an embodiment of present invention, aiming beam can be set to a diameter set within a range between 1 and 20 mm. In another embodiment of present invention, power density can be selected within a range of 10-100 J/cm. In yet another embodiment, the pulse duration of the pulsed radiation energy transmitted to through a waveguide and/or handpiece onto the ulcer wound being treated, in a non-contact mode, is selected within a range of about 10-100 msec.

As depicted in the previous example, particular pre-treatment methods can be especially advantageous in wound healing when used in conjunction with the present laser device. For example, laser therapy can be preceded by mechanically scraping (debriding) the surface of the wound. Debriding removes necrotic tissue and debris from the wound surface to prepare the wound site for laser therapy. A transparent wound cover with a bacteriostatic or bactericidal agent can then be applied to the wound site to prevent microbial invasion and to allow moisture to escape from the wound surface. The photothermal energy selectively stimulates the lower papillary/upper reticular dermis which leads to fibroblast activation and synthesis of new collagen and extracellular matrix material. To further enhance the healing process, additional methods may be employed after the laser treatment to accelerate angiogenesis, and to increase the breakdown of dead tissue and fibrin. In most clinical cases, experienced physicians may prefer to set their own treatment values considering other clinical criteria.

Having described preferred embodiments of the invention with reference to the accompanying drawings, it is to be understood that the invention is not limited to the precise embodiments, and that various changes and modifications may be effected therein by skilled in the art without departing from the scope or spirit of the invention as defined in the appended claims.

What is claimed is:

1. An optical medical treatment device for irradiating and healing ulcer wounds.

2. The optical medical treatment device according to claim I comprising:
at least one radiation source;
at least one optical waveguide, having a proximal end and a distal end;
wherein at said proximal end, said waveguide is optically coupled to said radiation source, and said waveguide transmits said radiation to a wound site at its distal end;
a handpiece coupled to said at least one waveguide; and,
wherein said radiation source is capable of producing radiation at a preselected wavelength, a preselected power level and a preselected power density.

3. The medical treatment device of claim 2 further comprising an enclosure cap for confining irradiated area.

4. The medical treatment device of claim 2 further comprising a timer system to signal end of treatment.

5. The medical treatment device of claim 2 further comprising a sensing system to signal end of treatment according to changes in target tissue properties in area of said ulcer wounds.

6. The medical treatment device of claim 1 comprising a portable integrated handheld system.

7. The medical treatment device of claim 2, wherein said preselected wavelength is 1470±60 nm.

8. The fiber optic medical treatment device of claim 2, wherein said preselected power level is within the range of about 10-20 Watts.

9. The medical energy treatment device of claim 2, wherein said handpiece is capable of focusing laser energy to said wound site with a spot size within a range of about 1 to 20 mm in diameter.

10. The medical treatment device of claim 7, wherein said laser energy is preselected at a power level within a range of about 10-20 Watts.

11. A method of treating ulcer wounds whereby said ulcer wounds are biostimulated to accelerate said wounds' healing by applying a local energy source to said wounds.

12. The method of treating ulcer wounds according to claim 11, wherein said applying a local energy source employs radiating laser energy onto said wounds.

13. The method of treating ulcer wounds according to claim 11, wherein said laser energy is preselected at a wavelength of 1470±60 nm.

14. The method of treating ulcer wounds with an optical medical device according to claim 11, comprising the steps of:
preparing said ulcer wound for treatment;
selecting a wavelength, a power level and a power density;
transmitting pulsed radiation energy through a waveguide and/or a handpiece onto said wound in a, non-contact mode;
applying a hyaluronic acid jell to said ulcer wound, either before during or after radiation;
repeating the prior steps periodically until size of ulcer wound shrinks or disappears.

15. The method of treating ulcer wounds according to claim 14 wherein said step of preparing ulcer wound for treatment comprises the steps of cleaning said ulcer wound with normal saline or sterile water.

16. The method of treating ulcer wounds according to claim 14, wherein the step of selecting a wavelength, a power level, and a power density, involves the step of; employing an optical medical treatment device comprising at least one radiation source, optically coupled to at least one optical fiber and a handpiece to irradiate said ulcer wounds.

17. The method of treating ulcer wounds according to claim 14 wherein said pulse duration is selected within a range of about 10-100 msec.

18. The method of treating ulcer wound according to claim 14 wherein said power density is selected within a range of about 10-100 J/cm².

19. The method of treating ulcer wounds according to claim 14 further comprising the steps of
applying radiation energy to said ulcer wound in a point-to-point style; and
applying radiation energy outside the edges of said ulcer wound.

20. The method of treating ulcer wounds according to claim 14 further comprising the step of:
applying radiation energy to said ulcer wound starting at outermost edge and then going inwards in a circular or spiral-like manner.

21. The method of treating ulcer wounds according to claim 14 further comprising the step of:
applying radiation energy to said ulcer wounds until a termination point based on a preset timer or sensing system endpoint.
